(19) United States
(12) Patent Application Publication
(10) Pub. No.: US 2012/0001859 A1
(43) Pub. Date: Jan. 5, 2012

(54) DEVICE AND METHOD FOR DETECTING NOISE

(75) Inventors: Mun Se KIM, Seoul (KR); Min Soo KANG, Seoul (KR)

(73) Assignee: PANTECH CO., LTD., Seoul (KR)

(21) Appl. No.: 13/114,310

(22) Filed: May 24, 2011

(30) Foreign Application Priority Data
Jul. 1, 2010 (KR) 10-2010-0063632

(51) Int. Cl. G06F 3/041

(52) U.S. Cl. 345/173

(57) ABSTRACT

A touch screen device may include: a touch panel receiving a touch signal; a noise measurement unit measuring a noise value input to the touch panel; a determination unit determining whether or not the measured noise value exceeds a threshold; and a control unit controlling an operation mode to be maintained or switched according to a determination result of the determination unit.

### CROSS-REFERENCE TO RELATED APPLICATION

This application claims priority from and the benefit under 35 U.S.C. §119 of a Korean Patent Application No. 10-2010-0063632, filed on Jul. 1, 2010, which is incorporated by reference for all purposes as if fully set forth herein.

### BACKGROUND

1. Field

This disclosure is directed to a touch screen device capable of switching between modes using external noise as a trigger and a method using the same.

2. Discussion of the Background

With the recent trend towards reducing the weight and thickness of digital devices, such as, portable phones, refrigerators and computers, touch-sensing devices may is replace button-type switches as an input for digital devices.

Various types of the touch-sensing devices may include capacitive, resistive, pressure-sensitive, optical, and ultrasonic wave types. The capacitive touch sensing device is may be affected by external electrical noise, which in some cases may be due to the characteristics of a driving method associated with the device. These effects may cause a malfunction or cause the device to operate non-optimally.

### SUMMARY

This disclosure provides a touch screen device capable of switching an operation mode using external noise as an indicator, and a control method using the same.

Exemplary embodiments of the present invention provide a touch screen device, the device comprising a touch panel; a noise measurement unit to measure noise that affects the touch panel; a determination unit to determine whether the measured noise exceeds a predetermined threshold; and a control unit to switch an operation mode based on the determination of the determination unit.

Exemplary embodiments of the present invention provide a method for controlling a touch screen device comprising operating a touch panel in a first mode of the device; measuring a noise value; determining whether the measured noise value exceeds a predetermined threshold; and switching to a second mode of the device if the measured noise exceeds the predetermined threshold.

Exemplary embodiments of the present invention provide a device to control a touch panel, the device comprising a noise measurement unit to measure noise that affects the touch panel; a determination unit to determine whether the measured noise exceeds a predetermined threshold; and a control unit to switch an operation mode based on the determination of the determination unit.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a diagram of a configuration of a touch screen device according to an exemplary embodiment;

FIG. 2 is a flowchart according to an exemplary embodiment; and

FIGS. 3(a) and (b) are diagrams illustrating the changing of a valid input parameter according to an exemplary embodiment.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

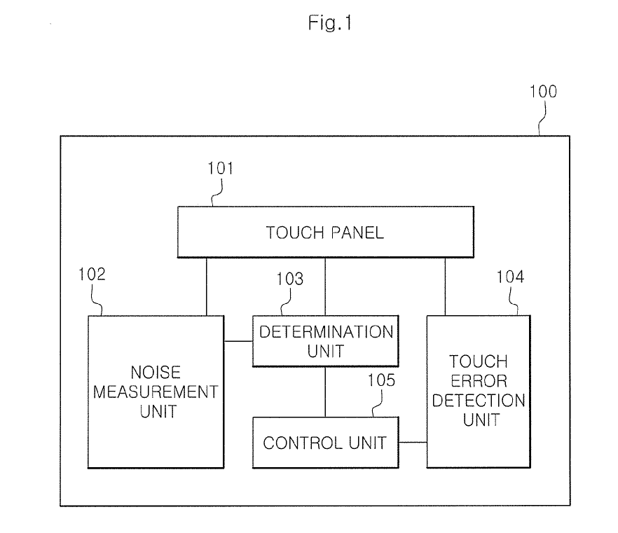

FIG. 1 is a diagram of a configuration of a touch screen device according to an exemplary embodiment.

Referring to FIG. 1, a touch screen device 100 includes a touch panel 101, a noise measurement unit 102, a determination unit 103, a touch error detection unit 104, and a control unit 105.

The touch panel 101 receives a touch signal from an object, such as a user touching a face of a screen. The touch panel 101 may receive an external signal. Once a touch panel receives an external signal, this signal may be converted from a stimulus, such as an exerted pressure, on or near a surface of the touch panel 101. Alternatively a change in capacitance at a particular site may be interpreted as an input signal used with a touch sensor. Several examples of touch sensor may be a touch film, a touch sheet, a touchpad, or the like.

In addition to detecting the touch of positions and areas, the touch sensor may detect pressure caused by touching and moving the object after touching. The signal sensed by the touch sensor is received by a touch controller, with the touch controller processing the sensed signal. The processed signal is then received by the control unit 105 for information processing.

If the touch panel 101 receives an input touch, which falls within a valid input parameter (defined below), the touch panel 101 recognizes the input touch as valid. Several examples of values used to determine a valid input parameter may include a touch threshold (a reference value of the capacitance used by the touch panel for recognizing a touch as an input signal), a touch detect indicator (a reference frequency of the touches that correspond to a change in capacitance that exceeds the reference of the touch threshold as an input signal), a touch detect sampling frequency (a frequency that corresponds to a sampling of the input signal for a reference time), and the like. Therefore, the touch panel 101 may use any of the above examples, or combinations of, to determine a valid signal.

The noise measurement unit 102 measures a value of the noise exposed to the touch panel.

The determination unit 103 may be used to determine whether the touch panel 101 enters or is in a noisy environment. The determination unit 103 accomplishes this determination by examining whether the measured noise value exceeds a threshold value. The determination unit 103 may use the noise value measured by the noise measurement unit 102. Thus, the determination unit 103 may have an arbitrary or preset noise value as a threshold and, in a case if the noise value input from the noise measurement unit 102 exceeds the threshold, may determine that the touch panel 101 now is affected by a noisy environment.

In addition, the determination unit 103 may determine periodically whether the noise value measured by the touch panel 101 exceeds or reaches a threshold required to operate the touch screen device 100 in a secondary operation mode. The switching of modes may occur in real time, and thus be based on direct environmental effects on the touch panel 101.

The touch error detection unit 104 detects a touch error signal, by comparing if an input signal corresponds to a valid input parameter, that may be preset by a user, of the touch panel 101. Thus, the touch error detection unit 104 may recognize and detect if the input signal is either a valid signal or an error signal, such as a signal caused by noise.

The control unit 105 may maintain or switch the operation mode of the touch screen device 100 between a normal operation or at least one other altered operational state, according to the determination made by the determination unit 103 or by a detected error from the touch error detection unit 104.

In one instance, if the determination unit 103 determines that the noise value measured by the touch panel 101 exceeds a predetermined threshold, such as a perceived touch due to noise factors, the control unit 105 may switch the operation mode to an error operation mode using an input threshold based on a valid input reference. The error operation mode is a state entered into if the touch screen device 100 is affected by a noisy environment. One such stimulus for entering into this state may be caused by a measured value of noise exceeding a predetermined threshold. In the error operation mode, the touch screen device 100 or the touch panel 101 may change the settings of the valid input parameters. For example, by setting or modifying one or more reference values of valid input parameters such as the touch threshold, the touch detect indicator, and the touch detect sampling frequency, a malfunction due to noise may be prevented.

The determination unit 103 may determine whether a noise value periodically measured by the touch panel 101 exceeds the threshold, and the control unit 105 may receive the determination result of the determination unit 103 in real time or with a delay, in order to switch the operation mode of the touch screen device 100. Thus, in a case in that the touch screen device 100 is set or has previously been set to be in the error operation mode, if it is determined that the noise value measured thereafter is within a threshold value range, the error operation mode may be exited, and the device may return to an alternate operating mode, such as the basic mode.

In addition, the control unit 105 may switch the operation mode of the touch screen device 100 based on a detection of a touch error signal from the touch error detection unit 104. Accordingly, in a case where the touch error signal is detected by the touch error detection unit 140 while the touch screen device 100 is already in an error operation mode, the mode may be switched to a different mode where even more strict references are applied as the valid input parameters. Thus, the touch screen device 100 may be iteratively configured based on real time noise detection.

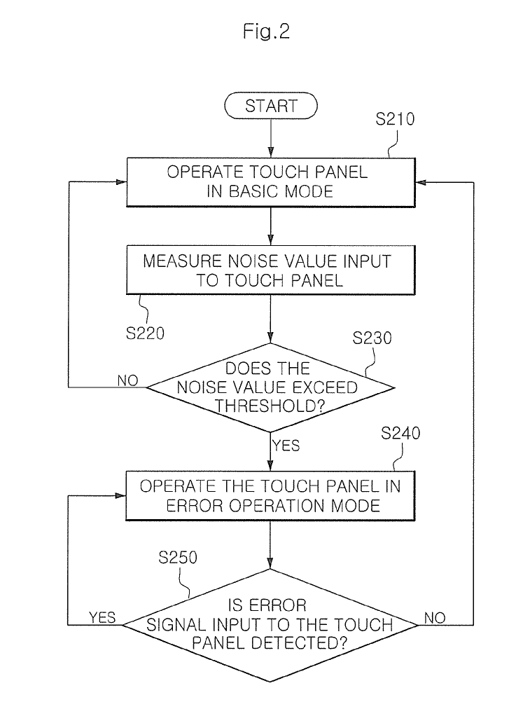

FIG. 2 is a flowchart according to an exemplary embodiment.

Referring to FIG. 2, a flowchart is shown exemplifying an operation using the concepts disclosed herein. A touch panel 101 is operating in a basic mode (S210). In the basic is mode (S210) the touch panel may measure the noise value seen by the input to the touch panel (S220). If it is determined that the measured noise value exceeds a predetermined threshold (S230), and the operation mode of the touch panel is in an environment in which noise exceeds the predetermined threshold, a determination is made that the touch screen device 100 may be prone to errors or in non-optimal operation. Thus, the touch screen device 100 operation mode may be switched to the error operation mode where stricter references are applied for touch input recognition (S240).

Once the touch screen device is in an error operation mode, a determination may be made whether an error signal is still capable of being input to the touch panel 101 (S250). If yes, the touch panel 101 may maintain the error operation mode, or alternatively, enter into a different error operation mode with stricter settings for the valid input parameters. If no, the touch panel 101 may be switched to a basic mode with the originally set valid input parameters.

For example, the touch panel 101 operating in the basic mode may be set with a touch threshold, a touch detect indicator, and a touch detect sampling frequency of 28, 2, and 10, respectively. The touch panel 101 according to the above setting samples a touch signal input to the touch panel 101 10 times per second, where a valid touch is defined as having capacitances that exceed 28 and at least consecutively detected two times, the input touch signals are determined as valid input signals. If the noise value measured by the touch panel 101 exceeds the threshold, the operation mode of the touch panel may be set with the touch threshold, the touch detect indicator, and the touch detect sampling frequency of 30, 2, and 10, respectively. Thus, noise, which may cause a simulated detection of noise due to a capacitance greater than 28 may now be ignored as long as the noise does not cause the touch panel to detect a capacitance of 30. Thus, based on the new values, the touch panel 101 samples touch signals input to the is touch panel 10 times per second, where a valid touch is defined as having capacitances that exceed 30 and is consecutively detected two times. This process may be iteratively performed. Thus, the touch panel 101 in an error operation mode as described above, may detect signals that still register as an error signal, i.e. are not valid input signals, may continuously maintain the error operation mode with a stricter threshold. For example, the valid input signal thresholds may be changed to 35, 3, and 63, respectively. In this case, it samples signals 63 times per second, and, only in a case where sampling signals having capacitances that exceed 35 are consecutively detected three times, detects the signals as valid input signals, thereby enhancing accuracy of input signals in the noisy environment and optimizing the operation of the touch screen device according to external environments. The kinds of parameters and values of the parameters applied to the operation mode may be modified in various manners, and are not limited to the modifications described above.

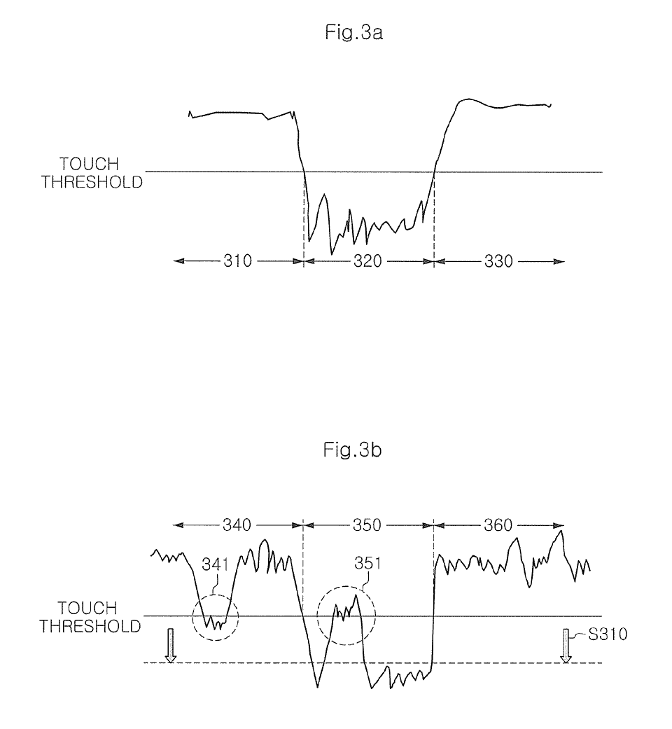

FIGS. 3(a) and (b) are diagrams illustrating the changing of a valid input parameter according to an exemplary embodiment.

FIG. 3(a) is a diagram that illustrates a change in capacitance detected by the touch panel 101 in an environment in which noise is almost exclusively below a reference value, and FIG. 3(b) is a diagram that illustrates a change in capacitance detected by the touch panel in a noisy environment, where the noise values exceed a threshold.

Referring to FIGS. 3(a) and (b), in the first and third sections, 310 and 330, of FIG. 3(a) and in the first and third sections, 340 and 360, of FIG. 3(b), a user of the touch panel 101 does not touch the device, thus generating no input touch signals. A touch signal generated by a user touching the device occurs in a second section 320 of FIG. 3(a) and in a second section 350 of FIG. 3(b). In FIG. 3(a), due to the absence of significant external noise, the touch screen is device detects a touch input in the second section 320 in which the capacitance exceeds the touch threshold and thus, the device operates properly. In FIG. 3(b), a change 341 in capacitance that exceeds the touch threshold may occur caused by noise and be detected by the touch panel 101 in the first section 340, even the case where there is no touch input from a user. Further, even a change 351 in capacitance that does not exceed the touch threshold may occur in the second section 350 in which a touch input does exist, also due to the presence of noise. Both of these situations, 341 and 351 may cause the device to not operate properly. However, because the threshold is changed (S310) and the touch input does register a capacitance higher than the threshold, a touch is detected. Therefore, in the case where the value of the noise is measured and the measured noise value exceeds the threshold, the touch screen device increases the reference of the touch threshold (S310) and switches the operation mode in order to prevent a malfunction.

In the disclosed touch screen device and the control method using the same, since noise is used as a trigger for the operation of the touch panel so as to switch the operation mode of the touch panel, one such advantage achieved is that the operation mode of the touch screen device can be set dynamically according to environmental effects.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary is embodiments and their equivalents disclosed as the best mode contemplated for carrying out this disclosure, but that this disclosure will include all embodiments falling within the scope of the appended claims.

What is claimed is:

1. A touch screen device, the device comprising:
a touch panel;
a noise measurement unit to measure noise that affects the touch panel;
a determination unit to determine whether the measured noise exceeds a predetermined threshold; and
a control unit to switch an operation mode based on the determination of the determination unit.

2. The touch screen device according to claim 1, wherein the control unit switches the operation mode to an error operation mode if the measured noise value exceeds the predetermined threshold.

3. The touch screen device according to claim 2,
wherein the device has a valid input parameter to determine that the touch panel receives a touch signal, the control unit changes the valid input parameter if the measured noise value exceeds the predetermined threshold.

4. The touch screen device according to claim 3, wherein the control unit changes the valid input parameter associated with the touch panel to a default value if the measured noise value is under a d predetermined threshold.

5. The touch screen device according to claim 3, further comprising a touch error detection unit to detect a touch error signal,
wherein the control unit determines a new value of the valid input parameter based on the detection of the detection unit.

6. The touch screen device according to claim 3, wherein the valid input parameter includes one or more of a touch threshold, a touch detect indicator, and a touch detect sampling frequency.

7. A method for controlling a touch screen device comprising:
operating a touch panel in a first mode of the device;
measuring a noise value;
determining whether the measured noise value exceeds a predetermined threshold; and
switching to a second mode of the device if the measured noise exceeds the predetermined threshold.

8. The method of claim 7, wherein the first mode and the second mode have respective valid input parameters.

9. The control method according to claim 7, further comprising switching back to the first mode from the second node if the noise value is measured to be within a predetermined threshold range.

10. The control method according to claim 7, further comprising:
detecting a touch error signal input to the touch panel; and
determining a new mode based on the detected touch error signal.

11. A device to control a touch panel, the device comprising:
a noise measurement unit to measure noise that affects the touch panel;
a determination unit to determine whether the measured noise exceeds a predetermined threshold; and
a control unit to switch an operation mode based on the determination of the determination unit.
